(19) United States
(12) Patent Application Publication
(10) Pub. No.: US 2025/0329150 A1
(43) Pub. Date: Oct. 23, 2025

(54) OBJECT INFORMATION PROCESSING METHOD AND APPARATUS, DEVICE, AND MEDIUM

(71) Applicant: TENCENT TECHNOLOGY (SHENZHEN) COMPANY LIMITED, Shenzhen (CN)

(72) Inventors: Chengfei CAI, Shenzhen (CN); Rongcheng TU, Shenzhen (CN)

(21) Appl. No.: 19/257,046

(22) Filed: Jul. 1, 2025

Related U.S. Application Data
(63) Continuation of application No. PCT/CN2023/128317, filed on Oct. 31, 2023.

(30) Foreign Application Priority Data
May 16, 2023 (CN) 202310553428.8

(51) Int. Cl. G06V 10/776; G06V 10/40; G06V 10/74; G06V 10/764; G06V 10/77; G06V 10/82

(52) U.S. Cl. CPC G06V 10/776; G06V 10/40; G06V 10/761; G06V 10/764; G06V 10/7715; G06V 10/82

(57) ABSTRACT

This application involves an object information processing method, including obtaining a sample set, the sample set comprising sample object information; obtaining a degree of label similarity between labels corresponding to any two pieces of sample object information in the sample set, and obtaining a degree of hash similarity; determining a difference between the degree of label similarity and the degree of hash similarity, and obtaining a first loss value based on the difference; determining, for each piece of sample object information in the sample set, a first degree of hash similarity between the sample object information and similar sample object information; determining a second degree of hash similarity; determining a second loss value according to the first degree of hash similarity and the second degree of hash similarity; and training the to-be-trained hash generation model according to the first loss value and the second loss value.

### RELATED APPLICATIONS

This application is a continuation of PCT Application No. PCT/CN 2023/128,317, filed on Oct. 31, 2023, which claims priority to Chinese Patent Application No. 2023105534288, filed on May 16, 2023, and entitled “OBJECT INFORMATION PROCESSING METHOD AND APPARATUS, DEVICE, AND MEDIUM”, which are both incorporated herein by reference in their entirety.

### FIELD OF THE TECHNOLOGY

This application relates to the field of artificial intelligence (“AI”), and in particular, to an object information processing method and apparatus, a device, and a medium.

### BACKGROUND OF THE DISCLOSURE

A hash code is a unique and extremely compact representation of a segment of data. A hash code of object information may be generated according to a feature of the object information by using a hash algorithm. With the development of computer technologies, generating a corresponding hash code from object information may be applied to many service fields in daily life. Therefore, generating an accurate hash code from object information has broad application value.

Usually, a trained hash generation model is configured for generating a hash code of object information. However, in a conventional method, in a process of training a hash generation model, only sample data in a current batch is considered in a loss value for guiding model optimization training. As such, if the model is trained in batches, an optimization result of a previous batch is easily damaged, and data can oscillate in a model training process. Consequently, performance of the hash generation model obtained through training is relatively poor, hash code generation accuracy of the object information is low, which may cause waste of hardware resources configured for supporting generation of the hash code of the object information.

### SUMMARY

Based on this, it is necessary to provide an object information processing method and apparatus, a device, and a medium for the above technical problems.

One aspect of this application provides an object information processing method, performed by a computer device and includes obtaining a sample set, the sample set comprising sample object information, and the sample object information having a corresponding label; obtaining a degree of label similarity between labels corresponding to any two pieces of sample object information in the sample set, and obtaining a degree of hash similarity between hash codes generated by a to-be-trained hash generation model for the any two pieces of sample object information; determining a difference between the degree of label similarity and the degree of hash similarity, and obtaining a first loss value based on the difference; determining, for each piece of sample object information in the sample set, a first degree of hash similarity between the sample object information and similar sample object information in the sample set, the similar sample object information being sample object information in the sample set that is similar to the sample object information; determining a second degree of hash similarity between the sample object information and dissimilar sample object information in the sample set, the dissimilar sample object information being sample object information in the sample set that is dissimilar to the sample object information; determining a second loss value according to the first degree of hash similarity and the second degree of hash similarity corresponding to each piece of sample object information in the sample set; and training the to-be-trained hash generation model according to the first loss value and the second loss value, to obtain a trained hash generation model, the trained hash generation model being configured for generating a corresponding hash code for inputted target object information.

Another aspect of this application provides a computer device, including a memory and one or more processors, where the memory stores computer-readable instructions, and the processor implements operations in the foregoing method embodiments of this application when executing the computer-readable instructions.

Another aspect of this application provides one or more non-transitory computer-readable storage media, having computer-readable instructions stored therein, and when the computer-readable instructions are executed by one or more processors, operations in the method embodiments of this application are implemented.

Details of one or more embodiments of this application are provided in the accompanying drawings and descriptions below. Other features, objectives, and advantages of this application become apparent from the specification, the drawings, and the claims.

### BRIEF DESCRIPTION OF THE DRAWINGS

To describe technical solutions in embodiments of this application or the conventional technology more clearly, the following briefly introduces the accompanying drawings required for describing the embodiments or the conventional technology. Apparently, the accompanying drawings in the following description show only embodiments of this application, and a person of ordinary skill in the art may still derive other drawings from the accompanying drawings without creative efforts.

FIG. 1 is an application environment diagram of an object information processing method according to an embodiment.

FIG. 2 is a schematic flowchart of an object information processing method according to an embodiment.

FIG. 3 is a schematic diagram of a conventional model training process and a model training process according to an embodiment of this application.

FIG. 4 is a flowchart of generating a hash code of target object information according to an embodiment.

FIG. 5 is a schematic diagram of a model structure of a hash generation model according to an embodiment.

FIG. 6 is a schematic flowchart of an object information processing method according to another embodiment.

FIG. 7 is a structural block diagram of an object information processing apparatus according to an embodiment.

FIG. 8 is a structural block diagram of an object information processing apparatus according to another embodiment.

FIG. 9 is an internal structural diagram of a computer device according to an embodiment.

FIG. 10 is a diagram of an internal structure of a computer device according to another embodiment.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

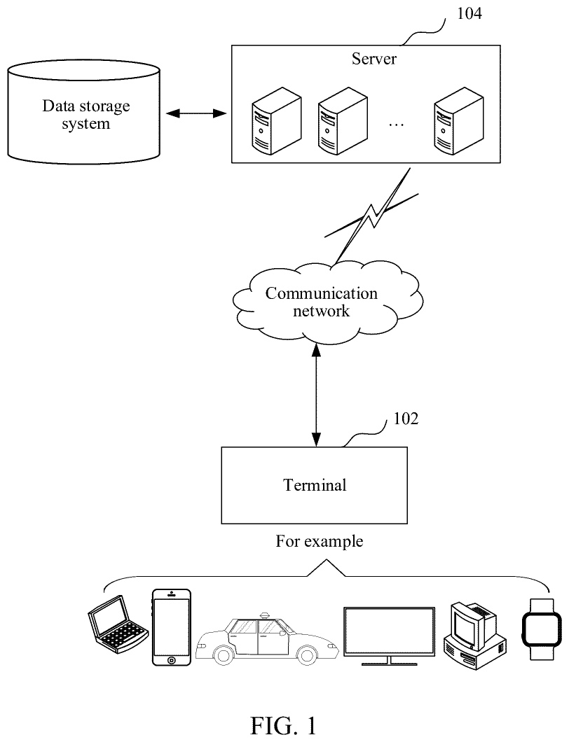

An object information processing method provided in this application may be implemented in an application environment shown in FIG. 1. A terminal 102 communicates with a server 104 by using a network. A data storage system may be separately disposed and may store data that needs to be processed by the server 104. The data storage system may be integrated on the server 104, or may be placed on cloud or another server. The terminal 102 may be but is not limited to various desktop computers, laptops, smartphones, tablet computers, Internet of Things devices, and portable wearable devices. The Internet of Things device may be an intelligent sound box, an intelligent television, an intelligent air conditioner, an intelligent in-vehicle device, or the like. The portable wearable device may be a smart watch, a smart band, a head-mounted device, and the like. The server 104 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, network security services such as cloud security, host security, a content delivery network (CDN), big data, and an AI platform. The terminal 102 and the server 104 may be directly or indirectly connected in a wired or wireless communication protocol. This is not limited in this application.

The server 104 may obtain a sample set, the sample set including sample object information, and the sample object information having a corresponding label. The server 104 may obtain a degree of label similarity between labels corresponding to any two pieces of sample object information in the sample set, and obtain a degree of hash similarity between hash codes generated by a to-be-trained hash generation model for the any two pieces of sample object information. The server 104 may determine a difference between the degree of label similarity and the degree of hash similarity, and obtain a first loss value based on the difference. The server 104 may determine, for each piece of sample object information in the sample set, a first degree of hash similarity between the sample object information and similar sample object information in the sample set, the similar sample object information being sample object information in the sample set that is similar to the sample object information. The server 104 may determine a second degree of hash similarity between the sample object information and dissimilar sample object information in the sample set, the dissimilar sample object information being sample object information in the sample set that is dissimilar to the sample object information. The server 104 may determine a second loss value according to the first degree of hash similarity and the second degree of hash similarity corresponding to each piece of sample object information in the sample set; and train the to-be-trained hash generation model according to the first loss value and the second loss value, to obtain a trained hash generation model, the trained hash generation model being configured for generating a corresponding hash code for inputted target object information.

The terminal 102 may obtain the target object information, and transmit the target object information to the server 104. The server 104 may input the target object information into the trained hash generation model, so as to generate the hash code of the target object information by using the trained hash generation model. The server 104 may further perform information retrieval based on the hash code of the target object information, and feedback retrieved information to the terminal 102. This is not limited in this embodiment. The application scenario in FIG. 1 is merely illustrative and is not limiting.

Object information processing methods in some embodiments of this application use an AI technology. For example, the hash code of the sample object information is generated by using the AI technology, that is, by using the to-be-trained hash generation model. Moreover, the corresponding hash code of the target object information is also generated by using the AI technology, that is, by using the trained hash generation model. For ease of understanding AI and concepts AI are described in a related manner. Specifically, AI involves a theory, a method, a technology, and an application system that use a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

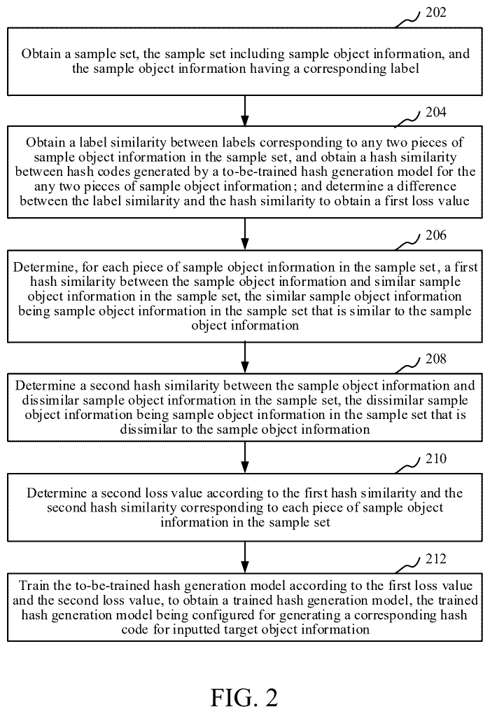

In an embodiment, as shown in FIG. 2, an object information processing method is provided. The method may be applied to a computer device. The computer device may be a terminal or a server. The method may be performed by the terminal or the server alone, or the method may be implemented through interaction between the terminal and the server. This embodiment is described by using an example in which the method is applied to a computer device. The method includes the following operations.

Operation 202: Obtain a sample set, the sample set including sample object information, and the sample object information having a corresponding label.

The sample set includes a plurality of pieces of sample object information, and each piece of sample object information in the sample set corresponds to at least one label. For ease of understanding, an example is used for description. If the sample object information is a description text “A little girl and her little dog play on a lawn”, the sample object information corresponds to three labels: “little girl”, “little dog”, and “lawn”.

In an embodiment, the sample object information may be an information group including object information in at least one modality. The sample object information may include at least one type of object information of: sample object image information of an object in an image modality, sample object text information of an object in a text modality, and sample object audio information of an object in an audio modality.

For example, the sample object information may be at least one of: image information in an image modality, text information in a text modality, and audio information in an audio modality, of the object “A little girl and her little dog play on a lawn”. The object “A little girl and her little dog play on a lawn” may be described by using at least one expression form of image, text, and audio.

Operation 204: Obtain a degree of label similarity between labels corresponding to any two pieces of sample object information in the sample set, and obtain a degree of hash similarity between hash codes generated by a to-be-trained hash generation model for the any two pieces of sample object information; and determine a difference between the degree of label similarity and the degree of hash similarity to obtain a first loss value.

The degree of label similarity is configured for representing a similarity between labels respectively corresponding to any two pieces of sample object information in the sample set. The degree of hash similarity is configured for representing a degree of similarity between hash codes respectively corresponding to any two pieces of sample object information in the sample set.

In an embodiment, the computer device may determine, according to labels respectively corresponding to any two pieces of sample object information in the sample set, a degree of label similarity between labels corresponding to the two pieces of sample object information. For each round of training, the computer device may respectively generate hash codes for any two pieces of sample object information in the sample set by using a hash generation model to be trained in this round, and determine a degree of hash similarity corresponding to the two pieces of sample object information according to the hash codes respectively corresponding to the two pieces of sample object information. Further, the computer device may determine a difference between the degree of label similarity and the degree of hash similarity corresponding to any two pieces of sample object information, to obtain the first loss value.

Operation 206: Determine, for each piece of sample object information in the sample set, a first degree of hash similarity between the sample object information and similar sample object information in the sample set, the similar sample object information being sample object information in the sample set that is similar to the sample object information.

The first degree of hash similarity is the similarity between the hash code of the sample object information and the hash code of the similar sample object information.

In an embodiment, for each piece of sample object information in the sample set, the computer device may obtain a hash code of the sample object information, and obtain a hash code of sample object information in the sample set that is similar to the sample object information. Further, the computer device may determine the similarity between the hash code of the sample object information and the hash code of the similar sample object information in the sample set, to obtain the first degree of hash similarity.

In an embodiment, for each piece of sample object information in the sample set, the computer device may extract a feature of the sample object information, and extract a feature of the sample object information in the sample set that is similar to the sample object information. Further, the computer device may perform hash coding on the feature of the sample object information, to obtain the hash code of the sample object information, and perform hash coding on the feature of the similar sample object information, to obtain the hash code of the sample object information in the sample set that is similar to the sample object information.

In an embodiment, the computer device may perform hash coding on each feature field in the feature of the sample object information, to obtain a hash bit corresponding to each feature field in the feature of the sample object information, and concatenate the hash bits corresponding to the feature fields in the feature of the sample object information, to obtain the hash code of the sample object information. Moreover, the computer device may perform hash coding on each feature field in the feature of the similar sample object information, to obtain the hash bit corresponding to each feature field in the feature of the similar sample object information, and concatenate the hash bits corresponding to the feature fields in the feature of the similar sample object information, to obtain the hash code of the sample object information in the sample set that is similar to the sample object information.

In an embodiment, for each piece of sample object information in the sample set, the computer device may determine a Hamming distance between the hash code of the sample object information and the hash code of the similar sample object information in the sample set, and determine the first degree of hash similarity according to the determined Hamming distance. The determined Hamming distance is negatively correlated to the sample degree of hash similarity. The first sample degree of hash similarity is a similarity between the hash code of the sample object information and the hash code of the similar sample object information in the sample set.

Operation 208: Determine a second degree of hash similarity between the sample object information and dissimilar sample object information in the sample set, the dissimilar sample object information being sample object information in the sample set that is dissimilar to the sample object information.

The second degree of hash similarity is the similarity between the hash code of the sample object information and the hash code of the dissimilar sample object information.

In an embodiment, for each piece of sample object information in the sample set, the computer device may obtain a hash code of the sample object information, and obtain a hash code of sample object information in the sample set that is similar to the sample object information. Further, the computer device may determine the similarity between the hash code of the sample object information and the hash code of the dissimilar sample object information in the sample set, to obtain the second degree of hash similarity.

In an embodiment, for each piece of sample object information in the sample set, the computer device may extract a feature of the sample object information, and extract a feature of the sample object information in the sample set that is dissimilar to the sample object information. Further, the computer device may perform hash coding on the feature of the sample object information, to obtain the hash code of the sample object information, and perform hash coding on the feature of the dissimilar sample object information, to obtain the hash code of the sample object information in the sample set that is dissimilar to the sample object information.

In an embodiment, the computer device may perform hash coding on each feature field in the feature of the sample object information, to obtain a hash bit corresponding to each feature field in the feature of the sample object information, and concatenate the hash bits corresponding to the feature fields in the feature of the sample object information, to obtain the hash code of the sample object information. Moreover, the computer device may perform hash coding on each feature field in the feature of the dissimilar sample object information, to obtain the hash bit corresponding to each feature field in the feature of the dissimilar sample object information, and concatenate the hash bits corresponding to the feature fields in the feature of the dissimilar sample object information, to obtain the hash code of the sample object information in the sample set that is dissimilar to the sample object information.

In an embodiment, for each piece of sample object information in the sample set, the computer device may determine a Hamming distance between the hash code of the sample object information and the hash code of the dissimilar sample object information in the sample set, and determine the second degree of hash similarity according to the determined Hamming distance. The determined Hamming distance is negatively correlated to the second sample degree of hash similarity. The second sample degree of hash similarity is a similarity between the hash code of the sample object information and the hash code of the dissimilar sample object information in the sample set.

Operation 210: Determine a second loss value according to the first degree of hash similarity and the second degree of hash similarity corresponding to each piece of sample object information in the sample set.

In an embodiment, for each piece of sample object information in the sample set, the computer device may determine a global degree of hash similarity according to the first degree of hash similarity and the second degree of hash similarity corresponding to the sample object information. Further, the computer device may determine the second loss value according to the first degree of hash similarity and the global degree of hash similarity. The global degree of hash similarity is a degree of hash similarity corresponding to each piece of sample object information in the entire sample set. The global degree of hash similarity may include both the first degree of hash similarity and the second degree of hash similarity.

In an embodiment, the computer device may determine the second loss value according to a proportion of the first degree of hash similarity in the global degree of hash similarity.

Operation 212: Train the to-be-trained hash generation model according to the first loss value and the second loss value, to obtain a trained hash generation model, the trained hash generation model being configured for generating a corresponding hash code for inputted target object information.

The target object information is object information obtained after training of the to-be-trained hash generation model is completed to obtain the trained hash generation model, that is, object information obtained in an application stage and inputted to the trained hash generation model.

In an embodiment, the target object information is an information group including object information in at least one modality. The target object information may include at least one type of object information of: object image information of an object in an image modality, object text information of an object in a text modality, and object audio information of an object in an audio modality.

Specifically, the computer device may perform iterative training on the to-be-trained hash generation model according to the first loss value and the second loss value, and is stopped until an iteration stop condition is satisfied, to obtain the trained hash generation model. In the model application stage, the computer device may obtain the target object information, and input the target object information into the trained hash generation model, so as to predict the hash code of the target object information by using the trained hash generation model.

In an embodiment, the training the to-be-trained hash generation model according to the first loss value and the second loss value, to obtain a trained hash generation model includes: weighting the first loss value and the second loss value to obtain a target loss value; and training the to-be-trained hash generation model in a direction of reducing the target loss value, to obtain the trained hash generation model.

Specifically, the computer equipment may weight the first loss value and the second loss value to obtain the target loss value. Further, the computer device may perform training iterations on the to-be-trained hash generation model according to the target loss value, to obtain the trained hash generation model. In a process of obtaining the target loss value, both the first loss value and the second loss value are considered. In this embodiment, the hash generation model is trained by using the target loss value obtained by weighting the first loss value and the second loss value, so that the hash generation model obtained through training can further generate an accurate hash code, thereby improving hash code generation accuracy, and further avoiding a waste of a hardware resource configured for supporting generation of the object information hash code.

In the foregoing object information processing method, a sample set is obtained, the sample set including sample object information, and the sample object information having a corresponding label. A degree of label similarity between labels corresponding to any two pieces of sample object information in the sample set is obtained, and a degree of hash similarity between hash codes generated by a to-be-trained hash generation model for the any two pieces of sample object information is obtained; and a difference between the degree of label similarity and the degree of hash similarity is determined to obtain a first loss value. For each piece of sample object information in the sample set, a first degree of hash similarity between the sample object information and similar sample object information in the sample set is determined. A second degree of hash similarity between the sample object information and dissimilar sample object information in the sample set is determined. A second loss value is determined according to the first degree of hash similarity and the second degree of hash similarity corresponding to each piece of sample object information in the sample set. The to-be-trained hash generation model is trained according to the first loss value and the second loss value, to obtain a trained hash generation model. In a model training process, the first loss value considers a degree of label similarity and a degree of hash similarity of the sample object information, and the second loss value corresponding to each sample object information not only considers an association between the sample object information and similar sample object information in the entire sample set, but also considers repellence between the sample object information and dissimilar sample object information in the entire sample set. Accordingly, even if batch training is performed, sample object information is not close to or distant from each other for no reason, thereby avoiding data fluctuation in the model training process. Therefore, the hash generation model obtained through training by using the first loss value and the second loss value can generate an accurate hash code for the target object information, thereby improving hash code generation accuracy, and further avoiding a waste of a hardware resource configured for supporting generation of the object information hash code.

In the model training method of this application, the to-be-trained hash generation model may be trained in batches, or may not be trained in batches.

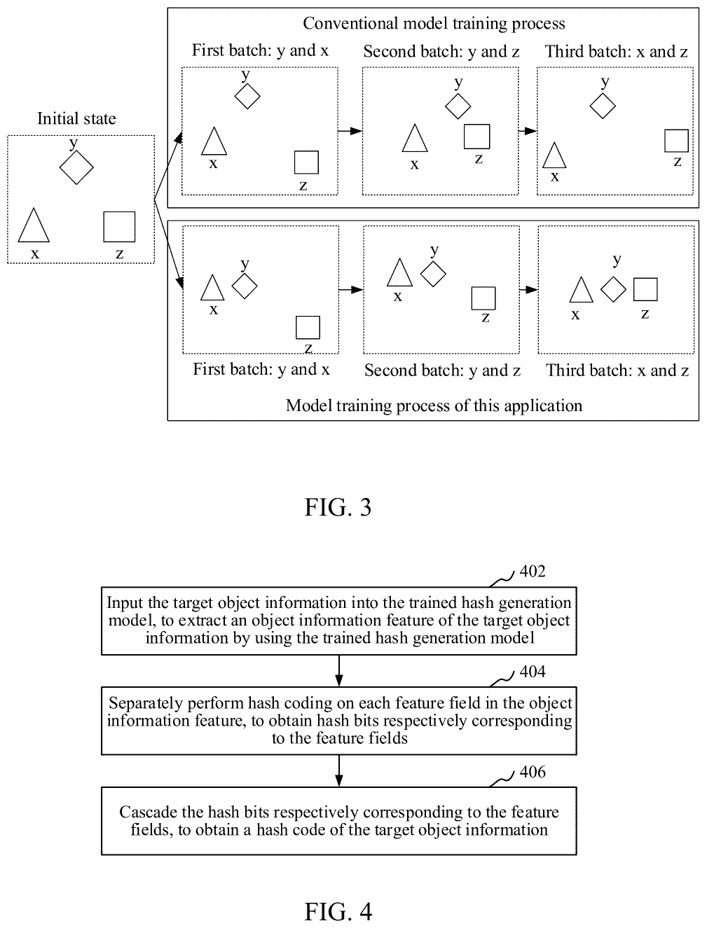

To further describe beneficial effects of this application, an example is used for description. As shown in FIG. 3, x, y, and z are respectively sample object information in a sample set, where x is similar to y (that is, containing the same label), z is similar to y (that is, containing the same label), and x is not similar to z (that is, not containing the same label). In three batches in the model training process, a first batch includes the sample object information y and x, a second batch includes the sample object information y and z, and a third batch includes the sample object information x and z. In a conventional model training process, only sample data in a current batch is considered for a loss value for guiding model optimization training. Accordingly, in a case that a model is trained in batches, an optimization result of a previous batch is easily damaged, and data easily fluctuates in the model training process. For example, an optimization result of the first batch is that x and y are close, an optimization result of the second batch is that z and y are close, and an optimization result of the third batch is that x and z are far away. However, x and y are also far away, and z and y are also far away. That is, a model optimization process of the third batch destroys the optimization results of model training of the first batch and the second batch. Consequently, performance of the hash generation model obtained through training is poor, and hash code generation accuracy of the object information is low.

Still referring to FIG. 3, because the first loss value in the model training process considers both a degree of label similarity and a degree of hash similarity of the sample object information, and the second loss value considers not only an association between the sample object information and similar sample object information in the entire sample set, but also a repellence between the sample object information and dissimilar sample object information in the entire sample set, the sample object information is not close to or distant from each other for no reason in the model training process, thereby avoiding data fluctuation in the model training process. For example, for model training of the third batch, in the model training method of this application, not only x and z being far away is considered, but also the optimization result of the first batch that x and y are close is kept, and the optimization result of the second batch that z and y are close is kept. Therefore, the hash generation model obtained through training by using the first loss value and the second loss value can generate an accurate hash code for the target object information, thereby improving hash code generation accuracy.

In an embodiment, the determining a second loss value according to the first degree of hash similarity and the second degree of hash similarity corresponding to each piece of sample object information in the sample set includes: determining, for each piece of sample object information in the sample set, a global degree of hash similarity according to the first degree of hash similarity and the second degree of hash similarity corresponding to the sample object information; determining, according to a ratio of the first degree of hash similarity to the global degree of hash similarity, a similarity ratio parameter corresponding to the sample object information; and determining the second loss value according to the similarity ratio parameter corresponding to each piece of sample object information in the sample set.

The similarity ratio parameter is configured for representing a ratio of the first degree of hash similarity to the global degree of hash similarity.

In an embodiment, for each piece of sample object information in the sample set, the computer device may add the first degree of hash similarity and the second degree of hash similarity corresponding to the sample object information, to obtain the global degree of hash similarity, and directly use the ratio of the first degree of hash similarity to the global degree of hash similarity as the similarity ratio parameter corresponding to the sample object information. Further, the computer device may determine the second loss value according to the similarity ratio parameter corresponding to each piece of sample object information in the sample set.

In an embodiment, the computer device may determine the difference between the degree of label similarity and the degree of hash similarity corresponding to any two pieces of sample object information, to obtain the first loss value. For each piece of sample object information in the sample set, the computer device may determine the first degree of hash similarity between the sample object information and similar sample object information in the sample set, and determine the second degree of hash similarity between the sample object information and dissimilar sample object information in the sample set. The computer device may determine, for each piece of sample object information in the sample set, the global degree of hash similarity according to the first degree of hash similarity and the second degree of hash similarity corresponding to the sample object information, determine the similarity ratio parameter corresponding to the sample object information according to the ratio of the first degree of hash similarity to the global degree of hash similarity, and determine the second loss value according to the similarity ratio parameter corresponding to each piece of sample object information in the sample set. Furthermore, the computer equipment may weight the first loss value and the second loss value to obtain the target loss value. Further, the computer device may perform training iterations on the to-be-trained hash generation model according to the target loss value, to obtain the trained hash generation model.

In an embodiment, the target loss value may be calculated using the following formula:

$${ℒ}_{p} = {‖ cos ( {b}_{i} , {b}_{j} ) - {s}_{ij} ‖}^{2} ;$$

$${s}_{ij} = \{ \begin{matrix}1 , & {l}_{i}^{T} {l}_{j} > 0 \\ - 1 , & {l}_{i}^{T} {l}_{j} = 0\end{matrix} ;$$

$$cos ( {b}_{i} , {b}_{j} ) = \frac{{b}_{i}^{T} {b}_{j}}{‖ {b}_{i} ‖ ‖ {b}_{j} ‖} = \frac{1}{k} {b}_{i}^{T} {b}_{j} ;$$

$${ℒ}_{s} = - \frac{1}{m} {\sum }_{i ∈ ϕ}^{m} {\sum }_{j ∈ {ϒ}_{i}} log \frac{exp ( \frac{1}{k} {b}_{i}^{T} {b}_{j} )}{exp ( \frac{1}{k} {b}_{i}^{T} {b}_{j} ) + {\sum }_{n ∈ {Ω}_{i}} exp ( \frac{1}{k} {b}_{i}^{T} {b}_{n} )} ;$$

$$ℒ = {ℒ}_{p} + {αℒ}_{s} ;$$

where sᵢⱼ indicates a similarity between a label lᵢ corresponding to sample object information i and a label lⱼ corresponding to sample object information

$$j \cdot {l}_{i}^{T} {l}_{j} > 0$$

indicates that the sample object information i and the sample object information j correspondingly have at least one same label.

$${l}_{i}^{T} {l}_{j} = 0$$

indicates that the sample object information i and the sample object information j do not correspondingly have the same label. k indicates a quantity of feature fields included in an object information feature of sample object information. bᵢ and bⱼ respectively indicate hash codes of the sample object information i and the sample object information j.cos(bᵢ, bⱼ) indicates a degree of hash similarity between the sample object information i and the sample object information j. [symbol] ₚ indicates the first loss value. m=|ϕ| indicates a quantity of sample object information in each training batch selected from a sample set. Yᵢ indicates a set of sample object information in the sample set that is similar to targeted sample object information (that is, the sample object information i). Ωᵢ indicates a set of sample object information in the sample set that is dissimilar to targeted sample object information (that is, the sample object information i).

$$exp ( \frac{1}{k} {b}_{i}^{T} {b}_{j} )$$

indicates the first degree of hash similarity, and

$$exp ( \frac{1}{k} {b}_{i}^{T} {b}_{n} )$$

indicates the second degree of hash similarity. [symbol] ₛ indicates the second loss value. α indicates a predefined weighting coefficient. [symbol] indicates a target loss value.

In the foregoing embodiment, the similarity ratio parameter corresponding to the sample object information is determined by using the ratio of the first degree of hash similarity to the global degree of hash similarity. The similarity ratio parameter may represent a proportion of the first degree of hash similarity in the global degree of hash similarity. Therefore, determining the second loss value according to the similarity ratio parameter corresponding to each piece of sample object information in the sample set can improve accuracy of the second loss value, thereby further improving hash code generation accuracy of the target object information in the model application process, and further avoiding a waste of a hardware resource configured for supporting generation of the object information hash code.

In an embodiment, the method further includes: using, for each piece of sample object information in the sample set, sample object information in the sample set that has at least one same label as the sample object information as sample object information similar to the sample object information; and using sample object information in the sample set that does not have a same label as the sample object information as sample object information dissimilar to the sample object information.

For ease of understanding, an example is used for description. If the targeted sample object information is a description text “A little girl and her little dog play on a lawn”, the sample object information corresponds to three labels: “little girl”, “little dog”, and “lawn”. Sample object information 1 is a description text “A little girl and a little boy play on a lawn”, and the sample object information 1 corresponds to three labels: “little girl”, “little boy”, and “lawn”. Sample object information 2 is a description text “A little duck swims in a pond”, and the sample object information 2 corresponds to two labels “little duck” and “pond”. Because the targeted sample object information and the sample object information 1 both correspond to the two labels “little girl” and “lawn”, it may be determined that the sample object information 1 is sample object information similar to the targeted sample object information. Because the targeted sample object information and the sample object information 2 do not correspond to the same label, it can be determined that the sample object information 2 is sample object information dissimilar to the targeted sample object information.

In the foregoing embodiment, the label corresponding to the sample object information may be configured for representing a type of the sample object information. A larger quantity of same labels corresponding to any two pieces of sample object information indicates that the two pieces of sample object information are more similar. Therefore, using sample object information in the sample set that has at least one same label as the targeted sample object information as sample object information similar to the targeted sample object information, accuracy of determining the similar sample object information can be improved. Sample object information in the sample set that does not have the same label with the sample object information is used as sample object information dissimilar to the targeted sample object information, so that accuracy of determining the dissimilar sample object information can be improved, thereby further avoiding a waste of hardware resources configured for supporting generation of the object information hash code.

In an embodiment, the determining a first degree of hash similarity between the sample object information and similar sample object information in the sample set includes: obtaining a first hash code generated by the to-be-trained hash generation model for the sample object information; obtaining a second hash code generated by the to-be-trained hash generation model for the sample object information in the sample set that is similar to the sample object information; and obtaining the first degree of hash similarity according to a similarity between the first hash code and the second hash code; and the determining a second degree of hash similarity between the sample object information and dissimilar sample object information in the sample set includes: obtaining a third hash code generated by the to-be-trained hash generation model for the sample object information in the sample set that is dissimilar to the sample object information; and obtaining the second degree of hash similarity according to a similarity between the first hash code and the third hash code.

Specifically, the computer device may input the sample object information into the to-be-trained hash generation model, so as to generate the hash code of the sample object information by using the to-be-trained hash generation model, to obtain the first hash code. The computer device may input the sample object information in the sample set and that is similar to the sample object information into the to-be-trained hash generation model, so as to generate a hash code of the sample object information in the sample set that is similar to the targeted sample object information by using the to-be-trained hash generation model, to obtain the second hash code. The computer device may input the sample object information in the sample set that is dissimilar to the sample object information to the to-be-trained hash generation model, so as to generate a hash code of the sample object information in the sample set that is dissimilar to the sample object information by using the to-be-trained hash generation model, to obtain the third hash code. Further, the computer device may obtain the first degree of hash similarity according to the similarity between the first hash code and the second hash code, and obtain the second degree of hash similarity according to the similarity between the first hash code and the third hash code.

In the foregoing embodiment, in the model training process, the first degree of hash similarity is obtained according to the similarity between the first hash code and the second hash code, so that accuracy of the first degree of hash similarity can be improved. Obtaining the second degree of hash similarity by using the similarity between the first hash code and the third hash code can improve accuracy of the second degree of hash similarity, thereby further avoiding a waste of a hardware resource configured for supporting generation of the object information hash code.

In an embodiment, as shown in FIG. 4, the method further includes:

Operation 402: Input the target object information into the trained hash generation model, to extract an object information feature of the target object information by using the trained hash generation model.

Operation 404: Separately perform hash coding on each feature field in the object information feature, to obtain hash bits respectively corresponding to the feature fields.

Operation 406: Cascade the hash bits respectively corresponding to the feature fields, to obtain a hash code of the target object information.

The feature field is a field configured for describing an object information feature. The hash bit is a component of the hash code. The hash code includes a plurality of hash bits.

In an embodiment, the computer device may input the target object information into the trained hash generation model, to perform convolutional processing on the input target object information by using the trained hash generation model, to extract the object information feature of the target object information. The object information feature includes at least one feature field, and the computer device may perform hash coding on each feature field in the object information feature by using a bitwise hash function, to obtain a hash bit corresponding to each feature field in the object information feature. Further, the computer device may cascade hash bits corresponding to the feature fields in the object information feature according to an arrangement order of the feature fields in the object information feature, to obtain the hash code of the target object information.

In an embodiment, the hash code of the target object information may be determined by using the following formula:

$${g}_{i} = {\{ {h}_{i}^{j} \}}_{j = 1}^{k} ;$$

$${\tilde{b}}_{ij} = {ℋ}^{j} ( {h}_{i}^{j} \vert {Γ}_{j} ) , j ∈ \{ 1 , ... , k \} ;$$

$${\tilde{b}}_{i} = \{ {{\tilde{b}}_{ij}}_{j = 1}^{k} \} ;$$

k indicates a quantity of feature fields

$${h}_{i}^{j}$$

included in an object information feature gᵢ of target object information i. [symbol] ^{j}(; Γⱼ) indicates a bitwise hash function configured for generating a jth hash bit \tilde{b}ᵢⱼ. \tilde{b}ᵢ indicates a hash code of target object information obtained after concatenation.

In the foregoing embodiment, the object information feature of the target object information is extracted, and field-level and fine-grained hash coding is separately performed on each feature field in the object information feature, to obtain a hash bit corresponding to each feature field. The hash bits corresponding to the feature fields are cascaded, to obtain the hash code of the target object information, so as to improve hash code generation accuracy of the target object information, thereby further avoiding a waste of a hardware resource configured for supporting generation of the object information hash code.

In an embodiment, the target object information is an information group including object information in at least two modalities. There is at least one piece of target object information, and the inputting the target object information into the trained hash generation model, to extract an object information feature of the target object information by using the trained hash generation model includes: inputting object information in each modality that is in the target object information into the trained hash generation model, to extract an information sub-feature of the object information in each modality by using the trained hash generation model; and fusing information sub-features respectively corresponding to object information in all modalities that is in the same target object information, to obtain the object information feature of the target object information.

The information sub-feature is a feature of object information in a single modality.

In an embodiment, the computer device may input object information in each modality that is in the target object information into the trained hash generation model, to extract an information sub-feature of the object information in each modality by using the trained hash generation model. The computer device may perform feature concatenation on information sub-features respectively corresponding to object information in all modalities that is in the same target object information, to obtain the object information feature of the target object information.

In an embodiment, the computer device may map information sub-features of object information in all modalities to the same feature space, to fuse, in the same feature space, mapped features respectively corresponding to object information in all modalities in the same target object information, to obtain the object information feature of the target object information.

In an embodiment, the target object information may include at least two types of object information: object image information of an object in an image modality, object text information of an object in a text modality, and object audio information of an object in an audio modality.

In the foregoing embodiment, in a case that the target object information is an information group including object information in at least two modalities, information sub-features of object information in all modalities are separately extracted, and information sub-features respectively corresponding to object information in all modalities that are in the same target object information are fused, to obtain the object information feature of the target object information, so that the object information feature of the target object information may include the information sub-features of the object information in all modalities, thereby improving accuracy of the object information feature of the target object information, and further avoiding a waste of a hardware resource configured for supporting generation of the object information hash code.

In an embodiment, the target object information includes object image information in an image modality and object text information in a text modality. The target object information includes object image information in an image modality and object text information in a text modality, and the information sub-feature includes an object image feature extracted for the object image information and an object text feature extracted for the object text information; and the fusing information sub-features respectively corresponding to object information in all modalities that is in the same target object information, to obtain the object information feature of the target object information includes: fusing the object image feature and the object text feature that are corresponding to the same target object information to obtain the object information feature of the target object information.

Specifically, the target object information includes object image information in an image modality and object text information in a text modality. The computer device may input the object image information and the object text information in the target object information into the trained hash generation model, to respectively extract an object image feature of the object image information and extract an object text feature of the object text information by using the trained hash generation model. Further, the computer device may fuse the object image feature and the object text feature that are corresponding to the same target object information to obtain the object information feature of the target object information.

In the foregoing embodiment, in a case that the target object information includes the object image information in the image modality and the object text information in the text modality, the object image feature and the object text feature that correspond to the same target object information are fused, to obtain the object information feature of the target object information, so that the object information feature of the target object information can include both the object image feature of the object image information and the object text feature of the object text information, thereby improving accuracy of the object information feature of the target object information, and further avoiding a waste of a hardware resource configured for supporting generation of the object information hash code.

In an embodiment, the fusing the object image feature and the object text feature that are corresponding to the same target object information to obtain the object information feature of the target object information includes: mapping the object image feature corresponding to the target object information to a target feature space, to obtain an image mapping feature; mapping the object text feature corresponding to the target object information to a target feature space, to obtain a text mapping feature; quantities of feature dimensions of the image mapping feature and the text mapping feature being the same in the target feature space; and fusing the image mapping feature and the text mapping feature that are corresponding to the same target object information to obtain the object information feature of the target object information.

The image mapping feature is a feature of the target object information in the target feature space. The text mapping feature is a feature of the target object information in the target feature space. Feature dimensions of the image mapping feature and the text mapping feature in the target feature space are the same. Feature vector dimensions of a feature vector of the image mapping feature and a feature vector of the text mapping feature in the target feature space are the same.

In an embodiment, for each piece of target object information, the computer device may map an object image feature corresponding to the target object information to the target feature space, to obtain an image mapping feature, and map an object text feature corresponding to the target object information to the target feature space, to obtain a text mapping feature. Quantities of feature dimensions of the image mapping feature and the text mapping feature are the same in the target feature space. Further, the computer device may fuse the image mapping feature and the text mapping feature that are corresponding to the same target object information to obtain the object information feature of the target object information.

In the foregoing embodiment, because quantities of feature dimensions of the image mapping feature and the text mapping feature in the target feature space are the same, the image mapping feature and the text mapping feature that correspond to the same target object information can be quickly fused, to obtain the object information feature of the target object information, thereby improving efficiency of obtaining the object information feature of the target object information, and further avoiding a waste of a hardware resource configured for supporting generation of the object information hash code.

In an embodiment, the trained hash generation model includes a feature processing network and a hash generation network; and the inputting the target object information into the trained hash generation model, to extract an object information feature of the target object information by using the trained hash generation model includes: inputting the target object information into the feature processing network, to extract an object information feature of the target object information by using the feature processing network; and the separately performing hash coding on each feature field in the object information feature, to obtain a hash bit respectively corresponding to each feature field includes: inputting the object information features into the hash generation network, to separately perform hash coding on each feature field in the object information feature, to obtain a hash bit respectively corresponding to each feature field.

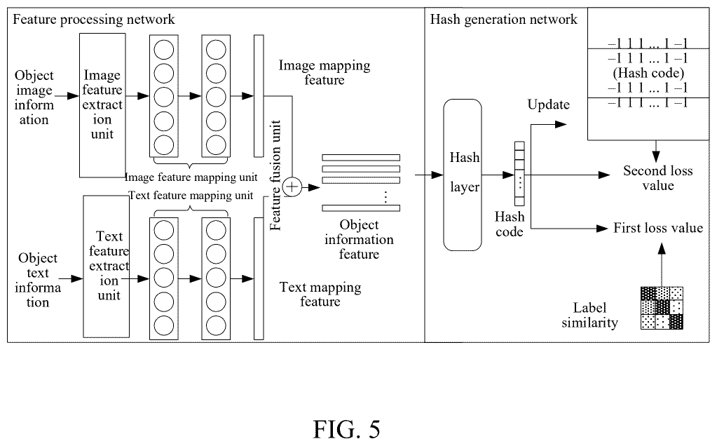

In an embodiment, referring to FIG. 5, the trained hash generation model includes a feature processing network and a hash generation network. In a model application stage, the computer device may input the target object information into the feature processing network, to extract an object information feature of the target object information by using the feature processing network. Further, the computer device may input the object information features into the hash generation network, to separately perform hash coding on each feature field in the object information features by using a hash layer of the hash generation network, to obtain a hash bit corresponding to each feature field, and concatenate the hash bits corresponding to the feature fields, to obtain the hash code of the target object information.

Still referring to FIG. 5, in a model training stage, the computer device may determine a difference between the degree of label similarity and the degree of hash similarity corresponding to any two pieces of sample object information, to obtain the first loss value. The degree of hash similarity is a similarity between hash codes generated by the to-be-trained hash generation model for any two pieces of sample object information. For each piece of sample object information in the sample set, a first degree of hash similarity between the sample object information and similar sample object information in the sample set is determined, a second degree of hash similarity between the sample object information and dissimilar sample object information in the sample set is determined, a second loss value is determined according to the first degree of hash similarity and the second degree of hash similarity corresponding to each piece of sample object information in the sample set, and the to-be-trained hash generation model is trained according to the first loss value and the second loss value, to obtain the trained hash generation model. In the model training stage, the hash code of sample object information is continuously updated.

In an embodiment, the feature processing network includes an image feature extraction unit, a text feature extraction unit, and a feature fusion unit, and the target object information includes object image information in an image modality and object text information in a text modality; and the inputting the target object information into the feature processing network, to extract an object information feature of the target object information by using the feature processing network includes: inputting the object image information to the image feature extraction unit, to extract an object image feature of the object image information by using the image feature extraction unit; inputting the object text information to the text feature extraction unit, so as to extract an object text feature of the object text information by using the text feature extraction unit; and inputting the object image feature and the object text feature to the feature fusion unit, to fuse the object image feature and the object text feature by using the feature fusion unit, to obtain the object information feature of the target object information.

In an embodiment, the target object information includes object image information in an image modality and object text information in a text modality. Still referring to FIG. 5, the feature processing network includes an image feature extraction unit, a text feature extraction unit, and a feature fusion unit. The computer device may input the object image information in the target object information into the image feature extraction unit, so as to extract an object image feature of the object image information by using the image feature extraction unit. Moreover, the computer device may input the object text information in the target object information into the text feature extraction unit, so as to extract an object text feature of the object text information by using the text feature extraction unit. Further, the computer device may input an object image feature and an object text feature corresponding to the same target object information to the feature fusion unit, so as to fuse, by using the feature fusion unit, the object image feature and the object text feature corresponding to the same target object information, to obtain an object information feature of the target object information. In this embodiment, the image feature extraction unit extracts the object image feature of the object image information, the text feature extraction unit extracts the object text feature of the object text information, and the feature fusion unit fuses the object image feature and the object text feature, to obtain the object information feature of the target object information, thereby further improving hash code generation accuracy, and further avoiding a waste of a hardware resource configured for supporting generation of the object information hash code.

In an embodiment, the feature processing network further includes an image feature mapping unit and a text feature mapping unit, and the inputting the object image feature and the object text feature to the feature fusion unit, to fuse the object image feature and the object text feature by using the feature fusion unit, to obtain the object information feature of target object information includes: inputting the object image feature into the image feature mapping unit, to map the object image feature to the target feature space by using the image feature mapping unit, to obtain an image mapping feature; inputting the object text feature into the text feature mapping unit, so as to map the object text feature to the target feature space by using the text feature mapping unit, to obtain a text mapping feature, quantities of feature dimensions of the image mapping feature and the text mapping feature being the same in the target feature space; and inputting the image mapping feature and the text mapping feature to the feature fusion unit, so as to fuse the image mapping feature and the text mapping feature by using the feature fusion unit, to obtain the object information feature of the target object information.

In an embodiment, still referring to FIG. 5, the feature processing network further includes an image feature mapping unit and a text feature mapping unit. For each piece of target object information, the computer device may input an object image feature corresponding to the target object information into the image feature mapping unit, so as to map the object image feature to the target feature space by using the image feature mapping unit, to obtain an image mapping feature. Moreover, the computer device may input an object text feature corresponding to the target object information to the text feature mapping unit, so as to map the object text feature to the target feature space by using the text feature mapping unit, to obtain a text mapping feature. Quantities of feature dimensions of the image mapping feature and the text mapping feature are the same in the target feature space. Further, the computer device may input an image mapping feature and a text mapping feature corresponding to the same target object information into the feature fusion unit, so as to fuse, by using the feature fusion unit, the image mapping feature and the text mapping feature corresponding to the same target object information, to obtain an object information feature of the target object information. In this embodiment, the image feature mapping unit maps the object image feature to the target feature space, to obtain the image mapping feature; the text feature mapping unit maps the object text feature to the target feature space, to obtain the text mapping feature; and the feature fusion unit fuses the image mapping feature and the text mapping feature, to obtain the object information feature of the target object information, thereby further improving hash code generation accuracy, and further avoiding a waste of a hardware resource configured for supporting generation of the object information hash code.

In an embodiment, the target object information includes object image information in an image modality and object text information in a text modality, which is represented as

$${o}_{i} = \{ {x}_{i}^{v} , {x}_{i}^{t} \} ,$$

where

$${x}_{i}^{v}$$

represents object image information in the target object information oᵢ, and

$${x}_{i}^{t}$$

represents object text information in the target object information oᵢ.

In an embodiment, the computer device may map the object image feature corresponding to the target object information to the target feature space by using the image feature mapping unit, to obtain the image mapping feature, which is represented as

$${g}_{i}^{v} = {MLP}^{v} ( {f}_{i}^{v} \vert {Θ}^{v} ) \cdot {MLP}^{v}$$

represents the image feature mapping unit, and Θ^{v} represents a unit parameter of the image feature mapping unit.

$${f}_{i}^{v}$$

represents an object image feature.

$${g}_{i}^{v}$$

represents an image mapping feature.

In an embodiment, the computer device may map the object text feature corresponding to the target object information to the target feature space by using the text feature mapping unit, to obtain the text mapping feature, which is represented as

$${g}_{i}^{t} = {MLP}^{t} ( {f}_{i}^{t} \vert {Θ}^{t} ) \cdot {MLP}^{t}$$

represents the text feature mapping unit, and θ^{t} represents a unit parameter of the text feature mapping unit

$${f}_{i}^{t}$$

represents an object text feature.

$${g}_{i}^{t}$$

represents a text mapping feature.

In an embodiment, the computer device may input an image mapping feature

$${g}_{i}^{v}$$

and a text mapping feature

$${g}_{i}^{t}$$

corresponding to the same target object information i into the feature fusion unit, so as to fuse, by using the feature fusion unit, the image mapping feature

$${g}_{i}^{v}$$

and the text mapping feature

$${g}_{i}^{t}$$

corresponding to the same target object information, to obtain an object information feature of the target object information, which is represented as

$${g}_{i} = {g}_{i}^{v} + {g}_{i}^{t} .$$

gᵢ represents the object information feature of the target object information.

In the foregoing embodiment, the target object information is inputted into the feature processing network, and the object information feature of the target object information is extracted by using the feature processing network, thereby improving accuracy of the object information feature of the target object information. Further, the object information feature is inputted into the hash generation network, so that hash coding is performed on each feature field in the object information feature by using the hash generation network, to obtain a hash bit corresponding to each feature field, thereby improving accuracy of the hash bit corresponding to each feature field, and further avoiding a waste of a hardware resource configured for supporting generation of the object information hash code.

In an embodiment, the method further includes: inputting the target object information into the trained hash generation model, so as to generate a hash code of the target object information by using the trained hash generation model; and determining, according to a similarity between the hash code of the target object information and a hash code of object information stored in a pre-constructed information retrieval library, object information that is in the object information stored in the information retrieval library and that matches the target object information.

Specifically, the object information and the corresponding hash code in the information retrieval library are associatively stored. The hash code may be used as an index for information retrieval. In an information retrieval scenario, the computer device may input the target object information into the trained hash generation model, so as to generate a hash code of the target object information by using the trained hash generation model. Further, the computer device may search, according to a similarity between the hash code of the target object information and a hash code of object information stored in a pre-constructed information retrieval library, object information that is in the object information stored in the information retrieval library and that matches the target object information. For example, the found object information may be object information having a relatively high similarity with the target object information.

In an embodiment, the hash code of the object information stored in the information retrieval library is generated in advance by using a trained hash generation model.

In an embodiment, the computer device may extract a feature of the hash code of the target object information and extract a feature of a hash code of stored object information in the information retrieval library. Further, the computer device may search, according to a similarity between the feature of the hash code of the target object information and the feature of the hash code of the stored object information, the object information stored in the information retrieval library for the object information matching the target object information. The stored object information is object information stored in the information retrieval library.

In the foregoing embodiment, the target object information is inputted into the trained hash generation model, so that the hash code of the target object information is generated by using the trained hash generation model, thereby improving accuracy of the hash code of the target object information. Further, the object information matching the target object information is determined from the object information stored in the information retrieval library directly by using the similarity between the hash code of the target object information and the hash code of the object information stored in the pre-constructed information retrieval library, so that accuracy of information retrieval can be improved on the premise of rapid retrieval, thereby avoiding a waste of a hardware resource configured for supporting information retrieval.

In an embodiment, the determining, according to a similarity between the hash code of the target object information and a hash code of object information stored in a pre-constructed information retrieval library, object information that is in the object information stored in the information retrieval library and that matches the target object information includes: determining a Hamming distance between the hash code of the target object information and the hash code of the object information stored in the information retrieval library, the Hamming distance being negatively correlated to a target degree of hash similarity, and the target degree of hash similarity being a similarity between the hash code of the target object information and the hash code of the object information stored in the information retrieval library; and determining, according to the Hamming distance, object information matching the target object information from the object information stored in the information retrieval library.

The Hamming distance is configured for indicating a quantity of different characters between hash bits corresponding to two hash codes. A Hamming distance between two hash codes is negatively correlated with a degree of hash similarity between the two hash codes.

In an embodiment, the computer device may determine the Hamming distance between the hash code of the target object information and the hash code of the object information stored in the information retrieval library, and determine, according to the determined Hamming distance, object information whose Hamming distance is less than a preset Hamming distance in the object information stored in the information retrieval library, to obtain the object information matching the target object information. The determined object information may be object information having a relatively high similarity with the target object information.

In an embodiment, a Hamming distance between two hash codes may be calculated by using the following formula:

$${d}_{H} ( {b}_{i} , {b}_{j} ) = \frac{1}{2} ( k - {b}_{i}^{T} {b}_{j} )$$

where bᵢ and bⱼ respectively represent hash codes of object information i and object information j, and k represents a quantity of feature fields included in an object information feature of object information. A quantity of feature fields included in an object information feature of the object information i is the same as a quantity of feature fields included in an object information feature of the object information j. d_{H} (bᵢ, bⱼ) represents a Hamming distance between hash codes of the object information i and the object information j.

In the foregoing embodiment, because a Hamming distance between two hash codes is negatively correlated to a degree of hash similarity corresponding to the two hash codes, the object information matching the target object information is determined in the object information stored in the information retrieval library by using the Hamming distance between the hash code of the target object information and the hash code of the object information stored in the information retrieval library, thereby improving information retrieval efficiency, and further avoiding a waste of a hardware resource configured for supporting information retrieval.

In an embodiment, the hash code of the object information stored in the information retrieval library is represented in a binary form. The method further includes: performing binarization processing on the hash code of the target object information, to obtain a binary hash code represented in a binary form of the target object information; and the determining, according to a similarity between the hash code of the target object information and a hash code of object information stored in a pre-constructed information retrieval library, object information that is in the object information stored in the information retrieval library and that matches the target object information includes: determining, according to a similarity between the binary hash code and the hash code of the object information stored in the information retrieval library, object information that is in the object information stored in the information retrieval library and that matches the target object information.

Specifically, the computer device may input the target object information into the trained hash generation model, so as to generate a hash code of the target object information by using the trained hash generation model. Further, the computer device may perform binarization processing on the hash code of the target object information, to obtain a binary hash code of the target object information represented in a binary form. The binary hash code is a hash code represented in a binary form. The computer device may determine, according to a similarity between the binary hash code and the hash code that is of the object information stored in the information retrieval library and that is represented in a binary form, the object information matching the target object information from the object information stored in the information retrieval library.

In an embodiment, the hash code of the object information stored in the information retrieval library is generated in advance by using a trained hash generation model. The hash code of the object information stored in the information retrieval library is represented in a binary form, and the hash code of the object information represented in the binary form is also obtained by performing binarization processing on the hash code of the object information stored in the information retrieval library.

In an embodiment, the computer device may perform binarization processing on the hash code of the target object information by using a sign function, to obtain a binary hash code of the target object information.

In an embodiment, the binary hash code of the target object information may be determined by using the following formula:

$${b}_{i} = sgn ( {\tilde{b}}_{i} )$$

where \tilde{b}ᵢ represents the hash code of the target object information, and sgn( ) represents the sign function, configured for generating a hash code with all 1s and −1. bᵢ represents the binary hash code of the target object information.

In the foregoing embodiment, the hash code of the object information stored in the information retrieval library is represented in a binary form, so that overheads of storage resources can be reduced. Because the hash code represented in a binary form may support a bit exclusive OR operation by using hardware, the object information matching the target object information is determined from the object information stored in the information retrieval base by using the similarity between the binary hash code and the hash code of the object information stored in the information retrieval base, which can reduce an operation amount of a retrieval process, improve information retrieval efficiency, and further avoid a waste of a hardware resource configured for supporting information retrieval.

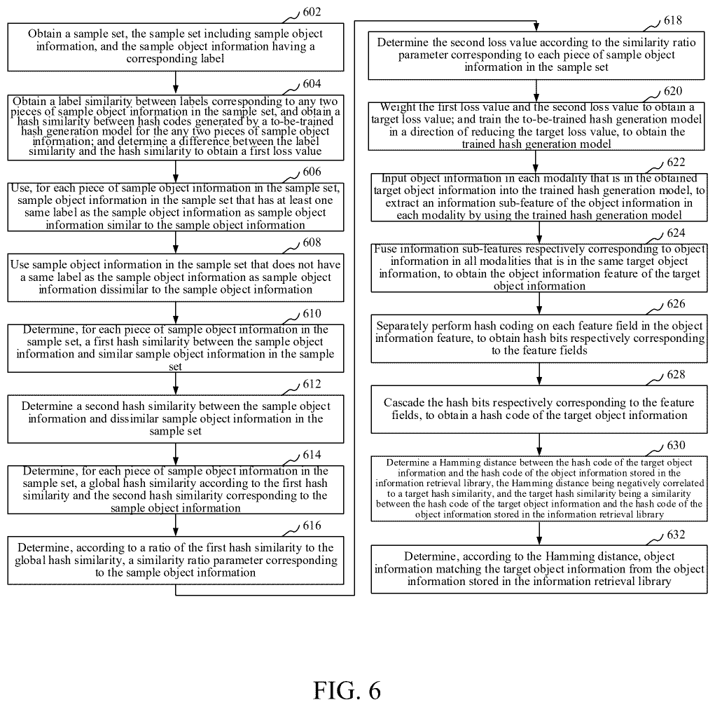

As shown in FIG. 6, in an embodiment, an object information processing method is provided. The method may be applied to a computer device. The computer device may be a terminal or a server. The method may be performed by the terminal or the server alone, or the method may be implemented through interaction between the terminal and the server. This embodiment is described by using an example in which the method is applied to a computer device. The method specifically includes the following operations.

Operation 602: Obtain a sample set, the sample set including sample object information, and the sample object information having a corresponding label.

Operation 604: Obtain a degree of label similarity between labels corresponding to any two pieces of sample object information in the sample set, and obtain a degree of hash similarity between hash codes generated by a to-be-trained hash generation model for the any two pieces of sample object information; and determine a difference between the degree of label similarity and the degree of hash similarity to obtain a first loss value.

Operation 606: Use, for each piece of sample object information in the sample set, sample object information in the sample set that has at least one same label as the sample object information as sample object information similar to the sample object information.

Operation 608: Use sample object information in the sample set that does not have a same label as the sample object information as sample object information dissimilar to the sample object information.

Operation 610: Determine, for each piece of sample object information in the sample set, a first degree of hash similarity between the sample object information and similar sample object information in the sample set.

Operation 612: Determine a second degree of hash similarity between the sample object information and dissimilar sample object information in the sample set.

Operation 614: Determine, for each piece of sample object information in the sample set, a global degree of hash similarity according to the first degree of hash similarity and the second degree of hash similarity corresponding to the sample object information.

Operation 616: Determine, according to a ratio of the first degree of hash similarity to the global degree of hash similarity, a similarity ratio parameter corresponding to the sample object information.

Operation 618: Determine the second loss value according to the similarity ratio parameter corresponding to each piece of sample object information in the sample set.

Operation 620: Weight the first loss value and the second loss value to obtain a target loss value; and train the to-be-trained hash generation model in a direction of reducing the target loss value, to obtain the trained hash generation model.

Operation 622: Input object information in each modality that is in the obtained target object information into the trained hash generation model, to extract an information sub-feature of the object information in each modality by using the trained hash generation model.

Operation 624: Fuse information sub-features respectively corresponding to object information in all modalities that is in the same target object information, to obtain the object information feature of the target object information.

Operation 626: Separately perform hash coding on each feature field in the object information feature, to obtain hash bits respectively corresponding to the feature fields.

Operation 628: Cascade the hash bits respectively corresponding to the feature fields, to obtain a hash code of the target object information.

Operation 630: Determine a Hamming distance between the hash code of the target object information and the hash code of the object information stored in the information retrieval library, the Hamming distance being negatively correlated to a target degree of hash similarity, and the target degree of hash similarity being a similarity between the hash code of the target object information and the hash code of the object information stored in the information retrieval library;

Operation 632: Determine, according to the Hamming distance, object information matching the target object information from the object information stored in the information retrieval library.

This application further provides an application scenario. The application scenario applies the foregoing object information processing method. Specifically, the object information processing method may be applied to a scenario of advertisement search. The object may include an advertisement, and the object information includes advertisement information. Specifically, the computer device may obtain a sample set, the sample set including sample advertisement information, and the sample advertisement information having a corresponding label; and obtain a degree of label similarity between labels corresponding to any two pieces of sample advertisement information in the sample set, and obtain a degree of hash similarity between hash codes generated by a to-be-trained hash generation model for the any two pieces of sample advertisement information; and determine a difference between the degree of label similarity and the degree of hash similarity to obtain a first loss value.

The computer device may use, for each piece of sample advertisement information in the sample set, sample advertisement information in the sample set that has at least one same label as the sample advertisement information as sample advertisement information similar to the sample advertisement information; use sample advertisement information in the sample set that does not have a same label as the sample advertisement information as sample advertisement information dissimilar to the sample advertisement information; determine, for each piece of sample advertisement information in the sample set, a first degree of hash similarity between the sample advertisement information and similar sample advertisement information in the sample set; determine a second degree of hash similarity between the sample advertisement information and dissimilar sample advertisement information in the sample set; determine, for each piece of sample advertisement information in the sample set, a global degree of hash similarity according to the first degree of hash similarity and the second degree of hash similarity corresponding to the sample advertisement information; determine, according to a ratio of the first degree of hash similarity to the global degree of hash similarity, a similarity ratio parameter corresponding to the sample advertisement information; determine the second loss value according to the similarity ratio parameter corresponding to each piece of sample advertisement information in the sample set; and train the to-be-trained hash generation model according to the first loss value and the second loss value, to obtain a trained hash generation model.

The computer device may input advertisement information in each modality that is in the target advertisement information into the trained hash generation model, to extract an information sub-feature of the advertisement information in each modality by using the trained hash generation model; fuse information sub-features respectively corresponding to advertisement information in all modalities that is in the same target advertisement information, to obtain the advertisement information feature of the target advertisement information; separately perform hash coding on each feature field in the advertisement information feature, to obtain hash bits respectively corresponding to the feature fields; and cascade the hash bits respectively corresponding to the feature fields, to obtain a hash code of the target advertisement information. The advertisement information may include advertisement image information of an advertisement in an image modality and advertisement text information in a text modality.

The computer device may determine a Hamming distance between the hash code of the target advertisement information and the hash code of the advertisement information stored in the information retrieval library, the Hamming distance being negatively correlated to a target degree of hash similarity, and the target degree of hash similarity being a similarity between the hash code of the target advertisement information and the hash code of the advertisement information stored in the information retrieval library; and determine, according to the Hamming distance, advertisement information matching the target advertisement information from the advertisement information stored in the information retrieval library, so that advertisement retrieval accuracy can be improved.

For ease of further understanding advertisement retrieval, an example is used for description. An image A1 and a text B1 that are configured for describing an advertisement are inputted. The image A1 and the text B1 are inputted to a trained hash generation model as an image-text pair, so as to generate a hash code of the image-text pair of the image A1 and the text B1 by using the trained hash generation model. Hash codes of candidate advertisement information (that is, also an image-text pair) generated by using the trained hash generation model are prestored in the information retrieval library. Each piece of candidate advertisement information and a corresponding hash code are associatively stored, and the corresponding hash code is used as a retrieval index. In a retrieval process, the computer device may separately calculate a Hamming distance between an inputted hash code of the image pair of the image AI and the text B1 and each hash code in the information retrieval library, so as to determine, in image-text pairs stored in the information retrieval library, an image-text pair matching the image pair of the image A1 and the text B1. For example, an image pair of an image A2 and a text B2 relatively similar to the image pair of the image A1 and the text B1 is found.

This application further provides an additional application scenario. The application scenario applies the foregoing object information processing method. Specifically, the object information processing method may be applied to a scenario of product sorting. The object may include a product, and the object information includes product information. The product information may include at least one of product image information of the product in an image modality, product text information of the product in a text modality, and product audio information of the product in an audio modality. According to the object information processing method in this application, accuracy of a hash code of the product information can be improved, thereby further improving accuracy of product sorting.

Although operations in the flowcharts of the foregoing embodiments are displayed in sequence, these operations are not necessarily performed in sequence. Unless otherwise explicitly specified in this application, execution of the operations is not strictly limited, and the operations may be performed in other sequences. Moreover, at least some of the operations in each embodiment may include a plurality of sub-operations or a plurality of stages. The sub-operations or stages are not necessarily performed at the same moment but may be performed at different moments. Execution of the sub-operations or stages is not necessarily sequentially performed, but may be performed alternately with other operations or at least some of sub-operations or stages of other operations.

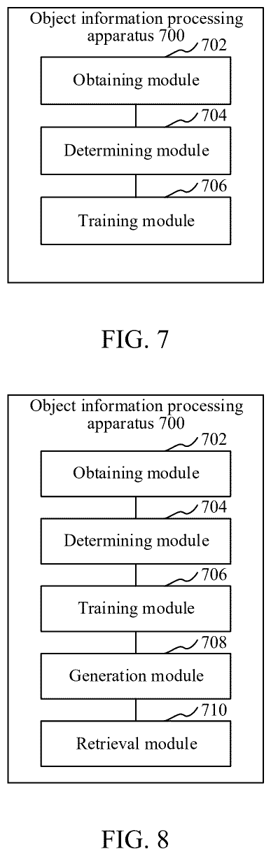

In an embodiment, as shown in FIG. 7, an object information processing apparatus 700 is provided, and the apparatus specifically includes:
an obtaining module 702, configured to obtain a sample set, the sample set including sample object information, and the sample object information having a corresponding label;
a determining module 704, configured to obtain a degree of label similarity between labels corresponding to any two pieces of sample object information in the sample set, and obtain a degree of hash similarity between hash codes generated by a to-be-trained hash generation model for the any two pieces of sample object information; and determine a difference between the degree of label similarity and the degree of hash similarity to obtain a first loss value; determine, for each piece of sample object information in the sample set, a first degree of hash similarity between the sample object information and similar sample object information in the sample set, the similar sample object information being sample object information in the sample set that is similar to the sample object information; determine a second degree of hash similarity between the sample object information and dissimilar sample object information in the sample set, the dissimilar sample object information being sample object information in the sample set that is dissimilar to the sample object information; and determine a second loss value according to the first degree of hash similarity and the second degree of hash similarity corresponding to each piece of sample object information in the sample set; and
a training module 706, configured to train the to-be-trained hash generation model according to the first loss value and the second loss value, to obtain a trained hash generation model; the trained hash generation model being configured for generating a corresponding hash code for inputted target object information.

In an embodiment, the determining module 704 is further configured to determine, for each piece of sample object information in the sample set, a global degree of hash similarity according to the first degree of hash similarity and the second degree of hash similarity corresponding to the sample object information; determine, according to a ratio of the first degree of hash similarity to the global degree of hash similarity, a similarity ratio parameter corresponding to the sample object information; and determine the second loss value according to the similarity ratio parameter corresponding to each piece of sample object information in the sample set.

In an embodiment, the determining module 704 is further configured to: use, for each piece of sample object information in the sample set, sample object information in the sample set that has at least one same label as the sample object information as sample object information similar to the sample object information; and use sample object information in the sample set that does not have a same label as the sample object information as sample object information dissimilar to the sample object information.

In an embodiment, the determining module 704 is further configured to obtain a first hash code generated by the to-be-trained hash generation model for the sample object information; obtain a second hash code generated by the to-be-trained hash generation model for the sample object information in the sample set that is similar to the sample object information; and obtain the first degree of hash similarity according to a similarity between the first hash code and the second hash code; obtain a third hash code generated by the to-be-trained hash generation model for the sample object information in the sample set that is dissimilar to the sample object information; and obtain the second degree of hash similarity according to a similarity between the first hash code and the third hash code.

In an embodiment, referring to FIG. 8, the object information processing apparatus 700 further includes:
a generation module 708, configured to input the target object information into the trained hash generation model, to extract an object information feature of the target object information by using the trained hash generation model; separately perform hash coding on each feature field in the object information feature, to obtain hash bits respectively corresponding to the feature fields; and cascade the hash bits respectively corresponding to the feature fields, to obtain a hash code of the target object information.

In an embodiment, the target object information is an information group including object information in at least two modalities. There is at least one piece of target object information, and the generation module 708 is further configured to input object information in each modality that is in the target object information into the trained hash generation model, to extract an information sub-feature of the object information in each modality by using the trained hash generation model; and fuse information sub-features respectively corresponding to object information in all modalities that is in the same target object information, to obtain the object information feature of the target object information.

In an embodiment, the target object information includes object image information in an image modality and object text information in a text modality. The target object information includes object image information in an image modality and object text information in a text modality, and the information sub-feature includes an object image feature extracted for the object image information and an object text feature extracted for the object text information; and the generation module 708 is further configured to fuse the object image feature and the object text feature that are corresponding to the same target object information to obtain the object information feature of the target object information.

In an embodiment, the generation module 708 is further configured to map the object image feature corresponding to the target object information to a target feature space, to obtain an image mapping feature; map the object text feature corresponding to the target object information to a target feature space, to obtain a text mapping feature; quantities of feature dimensions of the image mapping feature and the text mapping feature being the same in the target feature space; and fuse the image mapping feature and the text mapping feature that are corresponding to the same target object information to obtain the object information feature of the target object information.

In an embodiment, the trained hash generation model includes a feature processing network and a hash generation network; and the generation module 708 is further configured to input the target object information into the feature processing network, to extract an object information feature of the target object information by using the feature processing network; and input the object information features into the hash generation network, to separately perform hash coding on each feature field in the object information feature, to obtain a hash bit respectively corresponding to each feature field.

In an embodiment, the feature processing network includes an image feature extraction unit, a text feature extraction unit, and a feature fusion unit, and the target object information includes object image information in an image modality and object text information in a text modality; and the generation module 708 is further configured to input the object image information to the image feature extraction unit, to extract an object image feature of the object image information by using the image feature extraction unit; input the object text information to the text feature extraction unit, so as to extract an object text feature of the object text information by using the text feature extraction unit; and input the object image feature and the object text feature to the feature fusion unit, to fuse the object image feature and the object text feature by using the feature fusion unit, to obtain the object information feature of the target object information.

In an embodiment, the feature processing network further includes an image feature mapping unit and a text feature mapping unit. The generation module 708 is further configured to input the object image feature into the image feature mapping unit, to map the object image feature to the target feature space by using the image feature mapping unit, to obtain an image mapping feature; input the object text feature into the text feature mapping unit, so as to map the object text feature to the target feature space by using the text feature mapping unit, to obtain a text mapping feature, quantities of feature dimensions of the image mapping feature and the text mapping feature being the same in the target feature space; and input the image mapping feature and the text mapping feature to the feature fusion unit, so as to fuse the image mapping feature and the text mapping feature by using the feature fusion unit, to obtain the object information feature of the target object information.

In an embodiment, referring to FIG. 8, the object information processing apparatus 700 further includes:
a retrieval module 710, configured to input the target object information into the trained hash generation model, so as to generate a hash code of the target object information by using the trained hash generation model; and determine, according to a similarity between the hash code of the target object information and a hash code of object information stored in a pre-constructed information retrieval library, object information that is in the object information stored in the information retrieval library and that matches the target object information.

In an embodiment, the retrieval module 710 is further configured to determine a Hamming distance between the hash code of the target object information and the hash code of the object information stored in the information retrieval library, the Hamming distance being negatively correlated to a target degree of hash similarity, and the target degree of hash similarity being a similarity between the hash code of the target object information and the hash code of the object information stored in the information retrieval library; and determine, according to the Hamming distance, object information matching the target object information from the object information stored in the information retrieval library.

In an embodiment, the hash code of the object information stored in the information retrieval library is represented in a binary form. The retrieval module 710 is further configured to perform binarization processing on the hash code of the target object information, to obtain a binary hash code of the target object information represented in a binary form; and determine, according to a similarity between the binary hash code and the hash code of the object information stored in the information retrieval library, object information that is in the object information stored in the information retrieval library and that matches the target object information.

In an embodiment, the training module 706 is further configured to weight the first loss value and the second loss value to obtain a target loss value; and train the to-be-trained hash generation model in a direction of reducing the target loss value, to obtain the trained hash generation model.

In the foregoing object information processing apparatus, a sample set is obtained, the sample set including sample object information, and the sample object information having a corresponding label. A degree of label similarity between labels corresponding to any two pieces of sample object information in the sample set is obtained, and a degree of hash similarity between hash codes generated by a to-be-trained hash generation model for the any two pieces of sample object information is obtained; and a difference between the degree of label similarity and the degree of hash similarity is determined to obtain a first loss value. For each piece of sample object information in the sample set, a first degree of hash similarity between the sample object information and similar sample object information in the sample set is determined. A second degree of hash similarity between the sample object information and dissimilar sample object information in the sample set is determined. A second loss value is determined according to the first degree of hash similarity and the second degree of hash similarity corresponding to each piece of sample object information in the sample set. The to-be-trained hash generation model is trained according to the first loss value and the second loss value, to obtain a trained hash generation model. In a model training process, the first loss value considers a degree of label similarity and a degree of hash similarity of the sample object information, and the second loss value corresponding to each sample object information not only considers an association between the sample object information and similar sample object information in the entire sample set, but also considers repellence between the sample object information and dissimilar sample object information in the entire sample set. Accordingly, even if batch training is performed, sample object information is not close to or distant from each other for no reason, thereby avoiding data fluctuation in the model training process. Therefore, the hash generation model obtained through training by using the first loss value and the second loss value can generate an accurate hash code for the target object information, thereby improving hash code generation accuracy, and further avoiding a waste of a hardware resource configured for supporting generation of the object information hash code.

All or some of the modules in the foregoing object information processing apparatus may be implemented by using software, hardware, and a combination thereof. The foregoing modules may be embedded in or independent of a processor in the computer device in a hardware form, or may be stored in a memory in the computer device in a software form, so that the processor invokes the software to execute operations corresponding to the foregoing modules.

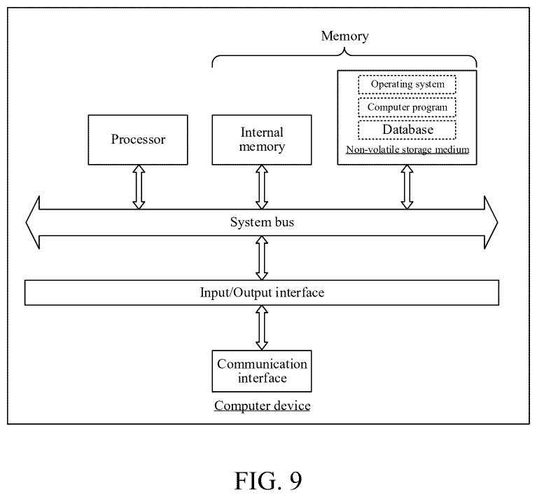

In an embodiment, a computer device is provided. The computer device may be a server, and an internal structure diagram of the computer device may be shown in FIG. 9. The computer device includes a processor, a memory, an input/output (briefly referred to as I/O) interface, and a communication interface. The processor, the memory, and the input/output interface are connected to each other by using a system bus, and the communication interface is connected to the system bus by using the input/output interface. The processor of the computer device is configured to provide a computing and control capability. The memory of the computer device includes a non-volatile storage medium and an internal memory. The non-volatile storage medium stores an operating system, computer readable instructions, and a database. The internal memory provides an environment for running an operating system and computer readable instructions in the non-volatile storage medium. The input/output interface of the computer device is configured to exchange information between the processor and an external device. The communication interface of the computer device is configured to communicate with an external terminal by using a network connection. The computer readable instructions are executed by the processor to implement an object information processing method.

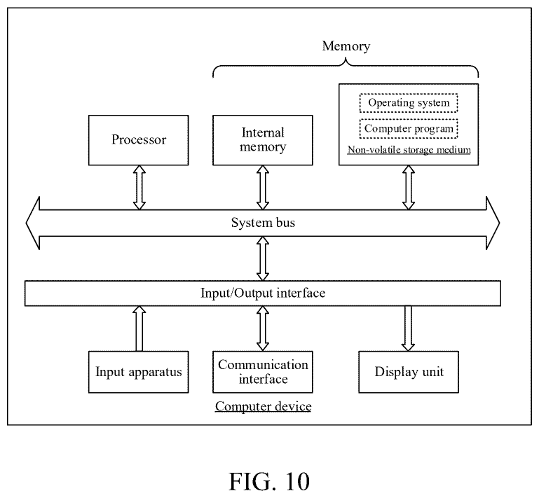

In an embodiment, a computer device is provided. The computer device may be a terminal, and an internal structure diagram of the computer device may be shown in FIG. 10. The computer device includes a processor, a memory, an input/output interface, a communication interface, a display unit, and an input apparatus. The processor, the memory, and the input/output interface are connected to each other by using a system bus, and the communication interface, the display unit, and the input apparatus are connected to the system bus by using the input/output interface. The processor of the computer device is configured to provide a computing and control capability. The memory of the computer device includes a non-volatile storage medium and an internal memory. The non-volatile storage medium stores an operating system and computer readable instructions. The internal memory provides an environment for running an operating system and computer readable instructions in the non-volatile storage medium. The input/output interface of the computer device is configured to exchange information between the processor and an external device. The communication interface of the computer device is configured to communicate with an external terminal in a wired or wireless manner. The wireless manner may be implemented by using Wi-Fi, a mobile cellular network, a near field communication (NFC), or another technology. The computer readable instructions are executed by the processor to implement an object information processing method. The display unit of the computer device is configured to form a visual picture, and may be a display screen, a projection apparatus, or a virtual reality imaging apparatus. The display screen may be a liquid crystal display screen or an electronic ink display screen. The input apparatus of the computer device may be a touch layer covering the display screen, may be a key, a trackball, or a touchpad disposed on a housing of the computer device, or may be an external keyboard, touchpad, or mouse.

A person skilled in the art may understand that the structure shown in FIG. 9 and FIG. 10 is merely a block diagram of a partial structure related to the solutions of this application, and does not constitute a limitation on the computer device to which the solutions of this application are applied. A specific computer device may include more or fewer components than those shown in the figure, or combine some components, or have different component arrangements.

In an embodiment, a computer device is further provided, including a memory and one or more processors, where the memory stores computer readable instructions, and the processor implements operations in the foregoing method embodiments when executing the computer readable instructions.

In an embodiment, one or more non-volatile computer readable storage media that store computer readable instructions are provided. When one or more processors execute the computer readable instructions, the operations in the foregoing method embodiments are implemented.

In an embodiment, a computer program product is provided, including computer readable instructions, and the computer readable instructions are executed by one or more processors to implement operations in the foregoing method embodiments.

User information (including but not limited to user device information, user personal information, and the like) and data (including but not limited to data configured for analysis, stored data, and displayed data) involved in this application are information and data that are authorized by a user or that are fully authorized by each party, and related data needs to be collected, used, and processed in compliance with relevant national laws and standards.

A person of ordinary skill in the art may understand that all or some of procedures of the method in the foregoing embodiments may be implemented by computer readable instructions instructing relevant hardware. The computer readable instructions may be stored in a non-volatile computer readable storage medium. When the computer readable instructions are executed, the procedures of the foregoing method embodiments may be implemented. Any reference to a memory, a storage, a database, or another medium used in the embodiments provided in this application may include at least one of a non-volatile memory and a volatile memory. The non-volatile memory may include a read-only memory (ROM), a magnetic tape, a floppy disk, a flash memory, or an optical storage. The volatile memory may include a random access memory (RAM) or an external cache. As an illustration but not a limitation, the RAM may be in multiple forms, such as a static random access memory (SRAM) or a dynamic random access memory (DRAM).

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

The foregoing embodiments only describe several implementations of this application, which are described specifically and in detail, but cannot be construed as a limitation to the patent scope of this application. For a person of ordinary skill in the art, several transformations and improvements can be made without departing from the idea of this application. These transformations and improvements belong to the protection scope of this application. Therefore, the protection scope of the patent of this application shall be subject to the appended claims.

What is claimed is:

1. An object information processing method, performed by a computer device and comprising:
obtaining a sample set, the sample set comprising sample object information, and the sample object information having a corresponding label;
obtaining a degree of label similarity between labels corresponding to any two pieces of sample object information in the sample set, and obtaining a degree of hash similarity between hash codes generated by a to-be-trained hash generation model for the any two pieces of sample object information;
determining a difference between the degree of label similarity and the degree of hash similarity, and obtaining a first loss value based on the difference;
determining, for each piece of sample object information in the sample set, a first degree of hash similarity between the sample object information and similar sample object information in the sample set, the similar sample object information being sample object information in the sample set that is similar to the sample object information;
determining a second degree of hash similarity between the sample object information and dissimilar sample object information in the sample set, the dissimilar sample object information being sample object information in the sample set that is dissimilar to the sample object information;
determining a second loss value according to the first degree of hash similarity and the second degree of hash similarity corresponding to each piece of sample object information in the sample set; and
training the to-be-trained hash generation model according to the first loss value and the second loss value, to obtain a trained hash generation model, the trained hash generation model being configured for generating a corresponding hash code for inputted target object information.

2. The method according to claim 1, wherein the determining a second loss value according to the first degree of hash similarity and the second degree of hash similarity corresponding to each piece of sample object information in the sample set comprises:
determining, for each piece of sample object information in the sample set, a global degree of hash similarity according to the first degree of hash similarity and the second degree of hash similarity corresponding to the sample object information;
determining, according to a ratio of the first degree of hash similarity to the global degree of hash similarity, a similarity ratio parameter corresponding to the sample object information; and
determining the second loss value according to the similarity ratio parameter corresponding to each piece of sample object information in the sample set.

3. The method according to claim 1, further comprising:
using, for each piece of sample object information in the sample set, sample object information in the sample set that has at least one same label as the sample object information as sample object information similar to the sample object information; and
using sample object information in the sample set that does not have a same label as the sample object information as sample object information dissimilar to the sample object information.

4. The method according to claim 1, wherein the determining a first degree of hash similarity between the sample object information and similar sample object information in the sample set comprises:
obtaining a first hash code generated by the to-be-trained hash generation model for the sample object information;
obtaining a second hash code generated by the to-be-trained hash generation model for the sample object information in the sample set that is similar to the sample object information; and
obtaining the first degree of hash similarity according to a similarity between the first hash code and the second hash code; and
the determining a second degree of hash similarity between the sample object information and dissimilar sample object information in the sample set comprises:
obtaining a third hash code generated by the to-be-trained hash generation model for the sample object information in the sample set that is dissimilar to the sample object information; and
obtaining the second degree of hash similarity according to a similarity between the first hash code and the third hash code.

5. The method according to claim 1, further comprising:
inputting the target object information into the trained hash generation model, to extract an object information feature of the target object information by using the trained hash generation model;
separately performing hash coding on each feature field in the object information feature, to obtain hash bits respectively corresponding to the feature fields; and
cascading the hash bits respectively corresponding to the feature fields, to obtain a hash code of the target object information.

6. The method according to claim 5, wherein the target object information is an information group comprising object information in at least two modalities, there is at least one piece of target object information, and the inputting the target object information into the trained hash generation model, to extract an object information feature of the target object information by using the trained hash generation model comprises:
inputting object information in each modality that is in the target object information into the trained hash generation model, to extract an information sub-feature of the object information in each modality by using the trained hash generation model; and
fusing information sub-features respectively corresponding to object information in all modalities that is in the same target object information, to obtain the object information feature of the target object information.

7. The method according to claim 6, wherein the target object information comprises object image information in an image modality and object text information in a text modality, and the information sub-feature comprises an object image feature extracted for the object image information and an object text feature extracted for the object text information; and
the fusing information sub-features respectively corresponding to object information in all modalities that is in the same target object information, to obtain the object information feature of the target object information comprises:
fusing the object image feature and the object text feature that are corresponding to the same target object information to obtain the object information feature of the target object information.

8. The method according to claim 7, wherein the fusing the object image feature and the object text feature that are corresponding to the same target object information to obtain the object information feature of the target object information comprises:
mapping the object image feature corresponding to the target object information to a target feature space, to obtain an image mapping feature;
mapping the object text feature corresponding to the target object information to the target feature space, to obtain a text mapping feature, quantities of feature dimensions of the image mapping feature and the text mapping feature being the same in the target feature space; and
fusing the image mapping feature and the text mapping feature that are corresponding to the same target object information to obtain the object information feature of the target object information.

9. The method according to claim 5, wherein the trained hash generation model comprises a feature processing network and a hash generation network; and
the inputting the target object information into the trained hash generation model, to extract an object information feature of the target object information by using the trained hash generation model comprises:
inputting the target object information into the feature processing network, to extract an object information feature of the target object information by using the feature processing network; and
the separately performing hash coding on each feature field in the object information feature, to obtain a hash bit respectively corresponding to each feature field comprises:
inputting the object information features into the hash generation network, to separately perform hash coding on each feature field in the object information feature, to obtain a hash bit respectively corresponding to each feature field.

10. The method according to claim 9, wherein the feature processing network comprises an image feature extraction unit, a text feature extraction unit, and a feature fusion unit, and the target object information comprises object image information in an image modality and object text information in a text modality; and
the inputting the target object information into the feature processing network, to extract an object information feature of the target object information by using the feature processing network comprises:
inputting the object image information to the image feature extraction unit, to extract an object image feature of the object image information by using the image feature extraction unit;
inputting the object text information to the text feature extraction unit, so as to extract an object text feature of the object text information by using the text feature extraction unit; and
inputting the object image feature and the object text feature to the feature fusion unit, to fuse the object image feature and the object text feature by using the feature fusion unit, to obtain the object information feature of the target object information.

11. The method according to claim 10, wherein the feature processing network further comprises an image feature mapping unit and a text feature mapping unit, and the inputting the object image feature and the object text feature to the feature fusion unit, to fuse the object image feature and the object text feature by using the feature fusion unit, to obtain the object information feature of target object information comprises:
inputting the object image feature into the image feature mapping unit, to map the object image feature to the target feature space by using the image feature mapping unit, to obtain an image mapping feature;
inputting the object text feature into the text feature mapping unit, so as to map the object text feature to the target feature space by using the text feature mapping unit, to obtain a text mapping feature, quantities of feature dimensions of the image mapping feature and the text mapping feature being the same in the target feature space; and
inputting the image mapping feature and the text mapping feature to the feature fusion unit, so as to fuse the image mapping feature and the text mapping feature by using the feature fusion unit, to obtain the object information feature of the target object information.

12. The method according to claim 1, further comprising:
inputting the target object information into the trained hash generation model, to generate a hash code of the target object information by using the trained hash generation model; and
determining, according to a similarity between the hash code of the target object information and a hash code of object information stored in a pre-constructed information retrieval library, object information that is in the object information stored in the information retrieval library and that matches the target object information.

13. The method according to claim 12, wherein the determining, according to a similarity between the hash code of the target object information and a hash code of object information stored in a pre-constructed information retrieval library, object information that is in the object information stored in the information retrieval library and that matches the target object information comprises:
determining a Hamming distance between the hash code of the target object information and the hash code of the object information stored in the information retrieval library, the Hamming distance being negatively correlated to a target degree of hash similarity, and the target degree of hash similarity being a similarity between the hash code of the target object information and the hash code of the object information stored in the information retrieval library; and
determining, according to the Hamming distance, object information matching the target object information from the object information stored in the information retrieval library.

14. The method according to claim 12, wherein the hash code of the object information stored in the information retrieval library is represented in a binary form, and the method further comprises:
performing binarization processing on the hash code of the target object information, to obtain a binary hash code of the target object information represented in a binary form; and
the determining, according to a similarity between the hash code of the target object information and a hash code of object information stored in a pre-constructed information retrieval library, object information that is in the object information stored in the information retrieval library and that matches the target object information comprises:
determining, according to a similarity between the binary hash code and the hash code of the object information stored in the information retrieval library, object information that is in the object information stored in the information retrieval library and that matches the target object information.

15. The method according to claim 1, wherein the training the to-be-trained hash generation model according to the first loss value and the second loss value, to obtain a trained hash generation model comprises:
weighting the first loss value and the second loss value to obtain a target loss value; and
training the to-be-trained hash generation model in a direction of reducing the target loss value, to obtain the trained hash generation model.

16. A computer device, comprising a memory and one or more processors, the memory having computer-readable instructions stored therein, and the processor, when executing the computer-readable instructions, implementing an object information processing method, comprising:
obtaining a sample set, the sample set comprising sample object information, and the sample object information having a corresponding label;
obtaining a degree of label similarity between labels corresponding to any two pieces of sample object information in the sample set, and obtaining a degree of hash similarity between hash codes generated by a to-be-trained hash generation model for the any two pieces of sample object information;
determining a difference between the degree of label similarity and the degree of hash similarity, and obtaining a first loss value based on the difference;
determining, for each piece of sample object information in the sample set, a first degree of hash similarity between the sample object information and similar sample object information in the sample set, the similar sample object information being sample object information in the sample set that is similar to the sample object information;
determining a second degree of hash similarity between the sample object information and dissimilar sample object information in the sample set, the dissimilar sample object information being sample object information in the sample set that is dissimilar to the sample object information;
determining a second loss value according to the first degree of hash similarity and the second degree of hash similarity corresponding to each piece of sample object information in the sample set; and
training the to-be-trained hash generation model according to the first loss value and the second loss value, to obtain a trained hash generation model, the trained hash generation model being configured for generating a corresponding hash code for inputted target object information.

17. The computer device according to claim 16, wherein the determining a second loss value according to the first degree of hash similarity and the second degree of hash similarity corresponding to each piece of sample object information in the sample set comprises:
determining, for each piece of sample object information in the sample set, a global degree of hash similarity according to the first degree of hash similarity and the second degree of hash similarity corresponding to the sample object information;
determining, according to a ratio of the first degree of hash similarity to the global degree of hash similarity, a similarity ratio parameter corresponding to the sample object information; and
determining the second loss value according to the similarity ratio parameter corresponding to each piece of sample object information in the sample set.

18. The computer device according to claim 16, further comprising:
using, for each piece of sample object information in the sample set, sample object information in the sample set that has at least one same label as the sample object information as sample object information similar to the sample object information; and
using sample object information in the sample set that does not have a same label as the sample object information as sample object information dissimilar to the sample object information.

19. The computer device according to claim 16, wherein the determining a first degree of hash similarity between the sample object information and similar sample object information in the sample set comprises:
obtaining a first hash code generated by the to-be-trained hash generation model for the sample object information;
obtaining a second hash code generated by the to-be-trained hash generation model for the sample object information in the sample set that is similar to the sample object information; and
obtaining the first degree of hash similarity according to a similarity between the first hash code and the second hash code; and
the determining a second degree of hash similarity between the sample object information and dissimilar sample object information in the sample set comprises:
obtaining a third hash code generated by the to-be-trained hash generation model for the sample object information in the sample set that is dissimilar to the sample object information; and
obtaining the second degree of hash similarity according to a similarity between the first hash code and the third hash code.

20. One or more non-transitory computer-readable storage media, having computer-readable instructions stored therein, when the computer-readable instructions are executed by one or more processors, the operations of an object information processing method, comprising:
obtaining a sample set, the sample set comprising sample object information, and the sample object information having a corresponding label;
obtaining a degree of label similarity between labels corresponding to any two pieces of sample object information in the sample set, and obtaining a degree of hash similarity between hash codes generated by a to-be-trained hash generation model for the any two pieces of sample object information;
determining a difference between the degree of label similarity and the degree of hash similarity, and obtaining a first loss value based on the difference;
determining, for each piece of sample object information in the sample set, a first degree of hash similarity between the sample object information and similar sample object information in the sample set, the similar sample object information being sample object information in the sample set that is similar to the sample object information;
determining a second degree of hash similarity between the sample object information and dissimilar sample object information in the sample set, the dissimilar sample object information being sample object information in the sample set that is dissimilar to the sample object information;
determining a second loss value according to the first degree of hash similarity and the second degree of hash similarity corresponding to each piece of sample object information in the sample set; and
training the to-be-trained hash generation model according to the first loss value and the second loss value, to obtain a trained hash generation model, the trained hash generation model being configured for generating a corresponding hash code for inputted target object information.
